(19) United States
(12) Patent Application Publication
(10) Pub. No.: US 2024/0262992 A1
(43) Pub. Date: Aug. 8, 2024

(54) MASTERBATCH WITH BACTERIOSTATIC OR BACTERICIDAL ACTIVITY, PRODUCTION METHOD THEREOF AND USES OF SAME

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); INSTITUT NATIONAL DE RECHERCHE POUR L'AGRICULTURE, L'ALIMENTATION ET L'ENVIRONNEMENT, Paris (FR); INSTITUT NATIONAL DES SCIENCES ET INDUSTRIES DU VIVANT ET DE L'ENVIRONNEMENT, PARIS (FR)

(72) Inventors: Géraldine CARROT; Sarah BERNARDI, GIF-SURYVETTE (FR); Morgan GUILBAUD, LEVES (FR); David LE PORHO,, SURZUR (FR); Ronan FLOCH; Nicolas BADIER, LORIENT (FR)

(21) Appl. No.: 18/564,425

(22) PCT Filed: May 30, 2022
(86) PCT No.: PCT/FR2022/051016

§ 371 Date: Nov. 27, 2023

(30) Foreign Application Priority Data
May 31, 2021 (FR) FR2105707

(51) Int. Cl. C08L 23/06; C08J 5/18; C08L 79/02

(52) U.S. Cl. CPC C08L 23/06; C08J 5/18; C08L 79/02; C08J 2323/06; C08J 2379/02; C08L 2310/00

(57) ABSTRACT

A masterbatch including at least one thermoplastic polymer and at least one ionene polymer as well as to the production method thereof. Further, the use of such a masterbatch for producing an article having bacteriostatic or bactericidal properties.

### TECHNICAL FIELD

The present invention belongs to the technical field of antibacterial materials and, more particularly, of materials with a thermoplastic matrix comprising polymers with bacteriostatic or bactericidal activity of the ionene type.

More particularly, the present invention relates to a composition of the masterbatch type comprising a thermoplastic resin and polyionenes as well as its production method. The present invention also relates to the various uses of this composition. Indeed, it can be used, directly or after dilution in a thermoplastic, for the preparation of active items made of plastic, capable of controlling, limiting or inhibiting the bacterial growth of undesired flora (spoilage and pathogenic), both for uses in the agri-food field and in the health, medical, military or environmental field.

### Prior Art

For economic, health and/or environmental reasons, there is an increasing demand over the last few years for antibacterial surfaces or coatings that allow a durable action of decontamination in the field of packaging for food products such as fresh food products, of the environment, or of the medical-hospital sphere.

Various strategies have been proposed in order to confer antibacterial properties onto polyethylene, or more generally onto polyolefins or plastic materials.

A first method involves the adsorption of small organic molecules, such as nisin [1] or ascorbic acid [2], or essential oils, such as thymol [3] or carvacrol [4], onto the surfaces. This method is not ideal since the release of these molecules is inevitable when a molecule is adsorbed onto a surface. Not only these surfaces lose effectiveness over time, but the release of these molecules into the product can also lead to an alteration of the freshness or of the taste in the case of essential oils for example. More problematically, these molecules can also induce a toxicity for the consumer. Furthermore, these organic molecules generally resist very little to industrial methods at high temperature like the methods for extrusion of plastic films.

To overcome the lack of stability of the organic molecules at high temperature, a second method involves replacing them with inorganic nanoparticles. Thus, inorganic species such as silver [5], ZnO [6] or TiO_{2 [7}] are indeed very effective from an antibacterial point of view and it is even possible to control their release by using montmorillonite supports, clay barriers [8] or SiO_{2 [9}]. However, the toxicity of these species is recognised or suspected and the lack of hindsight as to the toxicity of nanoparticles in general prevents films containing nanoparticles from being put on the market, in particular in the agri-food industry.

In this field, antimicrobial polymers are of particular interest since they generally also have a long-term activity with in addition a high chemical stability (reduction of the residual toxicity and of the microbial resistance). Among them, the polycations containing quaternary ammonium salts and with a modulable amphiphilic nature have been described as capable of effectively disturbing the outer and cytoplasmic membrane of the cells causing lysis and thus cell death. It was uncovered that one of the key parameters for an effective antibacterial effect of the polymer is its amphiphilic nature, namely the hydrophobic/charge ratio. When these polymers are used as contact-active (bacteriostatic) coatings, it has been clearly shown that (i) the presence of sufficiently long hydrophobic chains is necessary to penetrate and burst the bacterial membrane, and (ii) high levels of positive charges are necessary to confer antimicrobial properties, independently of the length of the hydrophobic chains [11].

In this context, polyionenes (PI) or ionenes containing quaternary ammoniums, in the main chain of the polymer or backbone, separated by hydrophobic fragments, are candidates of particular interest [12-16]. Indeed, Strassburg et al have shown that polyionenes have particularly effective antimicrobial properties, mainly because of the presence of alkyl groups of variable length [13]. It has also been shown that these polymers have low cytotoxicity [14] and the Argawal group has also inserted ethoxyethyl and aliphatic segments into the structure of ionene to evaluate the influence of these segments on the biocidal activity and reinforce the biocompatibility of these polymers [15]. More recently, a complete study on the activity of ionenes was carried out by the groups of Hedrick and Yang on clinically isolated multiresistant (MDR) microorganisms [16]. This study revealed that these microorganisms, although resistant to numerous antibiotics, were sensitive to polyionenes.

The present inventors have already proposed a method for preparing a pro-adhesive coating with bacteriostatic or bactericidal properties aiming to obtain a bacteria trap [17,18]. This method involves a succession of adherent or grafted coatings, in a robust and/or covalent manner, from the initial substrate to the bacteriostatic or bactericidal polymers containing polyionenes.

The inventors have set the goal of proposing not a coating but a material, the production of which can be easily industrialised and allowing to manufacture items, on the surface of which the propagation of bacteria is limited by killing them (bactericidal) or by inhibiting their growth (bacteriostatic).

### DISCLOSURE OF THE INVENTION

The present invention allows to reach this goal that the inventors have set and thus relates to a composition with bacteriostatic or bactericidal properties aiming to obtain various items usable as bacteria traps.

The inventors propose directly incorporating the ionene polymers with bacteriostatic or bactericidal activity during the preparation of plastic films by extrusion. For this, a premix of polyionenes (PI)/thermoplastic polymers such as polyethylene (PE) is carried out in the form of a masterbatch, to be used directly in one of the dies of an extrusion line that allows to manufacture the multilayer films useful in the field of food packaging.

The presence of the PI in the multilayer films has been demonstrated via various techniques of characterisation and it has been shown that that the films thus formed have pro-adhesive and antibacterial properties (see the experimental part below). In the field of food packaging, the films prepared from the masterbatch according to the invention, both pro-adhesive and bacteriostatic/bactericidal, allow to trap the undesirable flora (spoilage and pathogenic) in an irreversible manner and have an impact of particular interest both economically and environmentally. Indeed, they are particularly useful for a better conservation of fresh products, an extended use-by date and a reduction of the food waste in the packaging field.

The use of polymers of the ionene type (ionene polymers) offers the advantage of having a bacteriostatic or bactericidal property that is both pro-adhesive (the bacteria are trapped) and modulable in terms of the bactericidal power. Indeed, according to the monomers (dihalogens and diamines) used to prepare these polymers, it is possible to inhibit, totally or partly, the strains involved. Moreover, in the present invention, there is no limitation as to the usable ionene polymers.

Furthermore, according to the technique used to prepare the masterbatch subject-matter of the present invention, it is possible to avoid the release of PI by creating covalent bonds between the PIs and the thermoplastic polymers via the addition of additives and/or the use of a reactive extrusion. It should be noted, however, that for certain uses, the release of PI can be desired.

Beyond the use in the agri-food industry, the present invention can also be applied very usefully in the health, medical, medical-hospital, military or environmental field in the broad sense, with a view to manufacturing, from said masterbatch, plastic items such as decontamination or purification objects including rods, probes and membranes and/or containers such as a tray, bottle, case and packaging film that can advantageously be used as “bacteria traps”, thus reducing the bacterial load in the packaged product. The low cytotoxicity of the polyionenes and their ability to limit the resistance of the bacteria are additional advantages for this type of use.

Thus, the present invention relates to a masterbatch comprising at least one thermoplastic polymer and at least one ionene polymer. The notion of masterbatch comes from plastics engineering. Indeed, the masterbatch, subject-matter of the present invention, is a composition with a bacteriostatic or bactericidal effect obtained by extrusion of a mixture comprising at least one thermoplastic polymer and at least one ionene polymer and optionally one or more additives.

In other words, the present invention relates to a masterbatch obtained by extrusion, comprising
at least one thermoplastic polymer and
at least one ionene polymer which comprises, in its main chain, a sequence of repetitive units, identical or different, each unit being chosen between the unit having the formula (III) and the unit having the formula (IV):

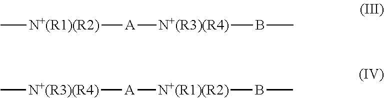

in which
R1, R2, R3 and R4, identical or different, represent an optionally substituted alkyl group or an optionally substituted aryl group;
A is a chain chosen from the group consisting of an optionally substituted alkylene chain, an optionally substituted alkenylene or alkynylene chain, an optionally substituted arylene chain, an optionally substituted alkylarylene chain and an optionally substituted arylalkylene chain; and
B is a chain chosen from the group consisting of an optionally substituted alkylene chain, an optionally substituted alkenylene or alkynylene chain, an optionally substituted arylene chain, an optionally substituted alkylarylene chain and an optionally substituted arylalkylene chain.

The masterbatch subject-matter of the present invention is in the form of a thermoplastic material in which and at the surface of which there are ionene polymers and optionally one or more additives.

The thermoplastic polymers also designated by the expression thermoplastic resins are materials that can be transformed in the melted state. Thus, in most of the manufacturing methods, the thermoplastics are heated, then formed in the fluid state (liquid, viscous or softened) by injection moulding, extrusion or thermoforming, before being cooled by means of which the finished product preserves its shape.

Typically, the thermoplastic polymer(s) usable in the context of the present invention are chosen from the group consisting of the polyamides; the saturated polyesters such as polyethylene terephthalate (PET) and polybutylene terephthalate (PBT); the polyethers; polyvinyl chloride (PVC); the vinyl copolymers; the polyolefins; the polyurethanes; the polycarbonates; the styrene polymers such as polystyrene (PS) and acrylonitrile butadiene styrene (ABS); and the poly(meth)acrylates such as polymethyl methacrylate (PMMA) as well as the combinations or mixtures thereof.

In a specific embodiment, the thermoplastic polymer(s) usable in the context of the present invention are chosen from the group consisting of the polyamides; the saturated polyesters such as polyethylene terephthalate (PET) and polybutylene terephthalate (PBT); polyvinyl chloride (PVC); the polyolefins; the styrene polymers such as polystyrene (PS) and acrylonitrile butadiene styrene (ABS); and the poly(meth)acrylates such as polymethyl methacrylate (PMMA) as well as the combinations or mixtures thereof.

In a more specific embodiment, the thermoplastic polymer(s) usable in the context of the present invention is/are one or more of the polyolefin(s) chosen from the group consisting of polyethylene (PE), low-density polyethylene (LDPE), linear low-density polyethylene (LLDPE), high-density polyethylene (HDPE), polypropylene (PP), polymethylpentene (PMP) and polybutene-1 (PB-1).

The total quantity of thermoplastic polymer(s) in the masterbatch subject-matter of the present invention is between 50% and 98% by weight, particularly between 70% and 97% and, in particular, between 80% and 96% by weight relative to the weight of said masterbatch.

“Ionene polymer” means, in the context of the present invention, a cationic polymer, all or a part of the positive charges of which are provided by quaternary ammoniums present in the main chain of the polymer, said positive charges being separated by hydrophobic segments. Below and above, the expressions and terms “polymer of the ionene type”, “ionene polymer”, “ionene”, “polyionene” and “PI” are equivalent and usable interchangeably.

Any ionene polymer capable of being obtained by reaction of a diamine and a dihalogen is usable in the context of the present invention.

Advantageously, the diamine used to prepare the ionene polymer usable in the method according to the invention has the formula (I):

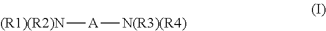

in which
R1, R2, R3 and R4, identical or different, represent a hydrogen atom, an optionally substituted alkyl group or an optionally substituted aryl group and, in particular, an optionally substituted alkyl group or an optionally substituted aryl group; and
A is a chain chosen from the group consisting of an optionally substituted alkylene chain, an optionally substituted alkenylene or alkynylene chain, an optionally substituted arylene chain, an optionally substituted alkylarylene chain and an optionally substituted arylalkylene chain.

“Alkyl group” means an alkyl group, linear, branched or cyclic, comprising from 1 to 20 carbon atoms, notably from 1 to 15 carbon atoms and, in particular, from 1 to 10 carbon atoms, said alkyl group optionally being capable of comprising at least one heteroatom and/or at least one double or triple carbon-carbon bond.

“Heteroatom” means, in the context of the present invention, an atom chosen from the group consisting of a nitrogen, an oxygen, a phosphorus, a sulphur, a silicon, a fluorine, a chlorine and a bromine.

“Substituted alkyl group” means, in the context of the present invention, an alkyl group as defined above substituted by a group or several groups, identical or different, chosen from the group consisting of a halogen; an amine; a diamine; a carboxyl; a carboxylate; an aldehyde; an ester; an ether; a ketone; a hydroxyl; an optionally substituted alkyl; an amide; a sulphonyl; a sulphoxide; a sulphonic acid; a sulphonate; a nitrile; a nitro; an acyl; an epoxy; a phosphonate; an isocyanate; a thiol; a glycidoxy and an acryloxy.

“Halogen” means, in the context of the present invention, an atom chosen from the group consisting of an iodine, a fluorine, a chlorine and a bromine.

Specific examples of alkyl groups usable for R1 to R4 include the methyl, ethyl, n-propyl, isopropyl, butyl, isobutyl, sec-butyl, tert-butyl, pentyl, isopentyl, hexyl, heptyl, octyl and nonyl groups.

“Aryl group” means, in the context of the present invention, any group comprising an aromatic cycle or several aromatics cycles, identical or different, linked or connected by a simple bond or by a hydrocarbon chain, an aromatic cycle having from 3 to 20 carbon atoms, notably from 4 to 14 carbon atoms and, in particular, from 5 to 8 carbon atoms and optionally being capable of comprising a heteroatom. As an aryl group usable in the invention, a phenyl group can be mentioned.

“Substituted aryl group” means, in the context of the present invention, an aryl group as defined above, substituted by a group or several groups, identical or different, chosen from the group consisting of a halogen; an amine; a diamine; a carboxyl; a carboxylate; an aldehyde; an ester; an ether; a ketone; a hydroxyl; an optionally substituted alkyl; an amide; a sulphonyl; a sulphoxide; a sulphonic acid; a sulphonate; a nitrile; a nitro; an acyl; an epoxy; a phosphonate; an isocyanate; a thiol; a glycidoxy and an acryloxy.

Specific examples of alkyl groups usable for R1 to R4 include the phenyl, biphenyl, naphthyl, anthracenyl, cyclopentadienyl, pyrenyl or naphthyl groups.

“Alkylene chain” means, in the context of the present invention, an alkylene chain, linear, branched or cyclic, comprising from 1 to 30 carbon atoms, notably from 2 to 20 carbon atoms and, in particular, from 3 to 15 carbon atoms, said alkylene chain optionally being capable of comprising at least one heteroatom.

“Alkenylene or alkynylene chain” means, in the context of the present invention, an alkenylene or alkynylene chain, linear, branched or cyclic, comprising from 2 to 30 carbon atoms, notably from 3 to 20 carbon atoms and, in particular, from 5 to 15 carbon atoms, said alkenylene or alkynylene chain optionally being capable of comprising at least one heteroatom.

“Arylene chain” means, in the context of the present invention, any chain comprising an aromatic cycle or several aromatic cycles, identical or different, linked or connected by a simple bond or by a hydrocarbon chain, an aromatic cycle having from 3 to 20 carbon atoms, notably from 4 to 14 carbon atoms and, in particular, from 5 to 8 carbon atoms and optionally being capable of comprising a heteroatom.

“Alkylarylene chain” means, in the context of the present invention, any chain derived from an arylene chain as defined above, one hydrogen atom of which is replaced by an alkyl group as defined above.

“Arylalkylene chain” means, in the context of the present invention, any chain derived from an alkylene chain as defined above, one hydrogen atom of which is replaced by an aryl group as defined above.

“Substituted alkylene chain”, “substituted alkenylene or alkynylene chain”, “substituted arylene chain”, “substituted alkylarylene chain” and “substituted arylalkylene chain” mean, in the context of the present invention, an alkylene chain, an alkenylene or alkynylene chain, an arylene chain, an alkylarylene chain and an arylalkylene chain as defined above substituted by one group or several groups, identical or different, chosen from the group consisting of a carboxyl; an carboxylate; an aldehyde; an ester; an ether; a ketone; a hydroxyl; an optionally substituted alkyl; an amide; a sulphonyl; a sulphoxide; a sulphonic acid; a sulphonate; a nitrile; a nitro; an acyl; an epoxy; a phosphonate; an isocyanate; a thiol; a glycidoxy and an acryloxy.

Examples of alkylene chains usable in the invention include a methylene, ethylene, propylene, butylene, pentylene, hexylene, heptylene, octylene, decylene, undecylene, dodecylene chain and a chain having the formula —(CH₂)ₙ—O—(CH₂)ₘ— or —(CH₂)ₙ—S—(CH₂)ₘ— with n and m, identical or different, representing 0 or an integer between 1 and 20 and with n+m greater than or equal to 1.

More specific examples of alkylene chains usable in the invention include a propylene, butylene, pentylene, hexylene, heptylene, octylene, decylene, undecylene, dodecylene chain and a chain having the formula —(CH₂)ₙ—O—(CH₂)ₘ— or —(CH₂)ₙ—S—(CH₂)ₘ— with n and m, identical or different, representing 0 or an integer between 1 and 20 and with n+m greater than or equal to 1.

Examples of arylene chains usable in the invention include a phenylene or biphenylene chain.

In a specific embodiment, the radicals R1, R2, R3 and R4 are identical. In a more specific embodiment, the radicals R1, R2, R3 and R4 are identical alkyl groups. In an even more specific embodiment, the radicals R1, R2, R3 and R4 are identical and represent a methyl or an ethyl.

Advantageously, the dihalogen used to prepare the ionene polymer usable in the method according to the invention has the formula (II):

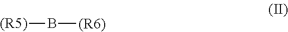

in which
R5 and R6, identical or different, represent a halogen; and
B is a chain chosen from the group consisting of an optionally substituted alkylene chain, an optionally substituted alkenylene or alkynylene chain, an optionally substituted arylene chain, an optionally substituted alkylarylene chain and an optionally substituted arylalkylene chain.

In a specific embodiment, the radicals R5 and R6 are identical. In a more specific embodiment, the radicals R5 and R6 are identical and represent a bromine atom, a chlorine atom or an iodine atom. In an even more specific embodiment, the radicals R5 and R6 are identical and represent a bromine atom.

Thus, the ionene polymer usable in the context of the present invention comprises, in its main chain, a chaining of repetitive units, identical or different, each unit being chosen between the unit having the formula (III) and the unit having the formula (IV):

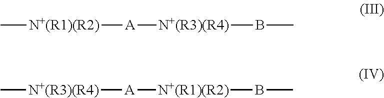

in which R1, R2, R3, R4, A and B are as defined above.

In a specific embodiment, the ionene polymer implemented in the present invention comprises, in its main chain, a chaining of repetitive units, identical or different, each unit having the formula (III) as defined above in which:
A represents an alkylene comprising from 3 to 12 carbon atoms and in particular 6 carbon atoms,
B represents an alkylene comprising from 3 to 12 carbon atoms and in particular 6 carbon atoms, and
the radicals R1, R2, R3 and R4, identical or different, represent a methyl or an ethyl.

Advantageously, in this specific embodiment, the radicals R1, R2, R3 and R4 are identical.

Typically, the ionene polymer is prepared via a polyaddition also known by the expression “Menshutkin reaction” involving at least one diamine having the formula (I) as defined above and at least one dihalide having the formula (II) as defined above. The radicals R1, R2, R3 and R4 carried by the diamine(s) and the radicals R5 and R6 carried by the dihalide(s) are the reactive functions during this polyaddition reaction.

The latter is carried out at a temperature greater than the ambient temperature. “Ambient temperature” means a temperature of 23° C.±5° C. Advantageously, the temperature during the polyaddition is greater than 30° C. Typically, the temperature during the polyaddition is between 40° C. and 80° C., in particular, between 55° C. and 75° C. and, more particularly, is approximately 65° C. (i.e. 65° C.±5° C.). Advantageously, during the polyaddition step, the diamine(s) and the dihalide(s) are in solution in a polar, protic or aprotic solvent. This solvent is in particular N,N-dimethylformamide (DMF) or a hydroxylated solvent, in particular, methanol, ethanol or one of the mixtures thereof, and more particularly methanol.

Via routine work, a person skilled in the art will be able to determine, without inventive effort, the quantity of diamine(s) and of halide(s) to implement according in particular to their solubility in the solvent as well as the duration of the polyaddition. For example, this duration can be between 4 h and 30 h, particularly between 5 h and 24 h and, in particular, between 6 h and 15 h. This polyaddition is typically carried out with stirring and, advantageously, under an inert atmosphere. It is stopped by cooling of the reaction medium.

The total quantity of polymer(s) of the ionene type in the masterbatch subject-matter of the present invention is between 0.5% and 50% by weight, notably between 1% and 30% and, in particular, between 2% and 10% by weight relative to the weight of said masterbatch. Specific examples of a masterbatch subject-matter of the present invention include a masterbatch comprising 3%, 5%, 10% by weight of ionene polymer(s) relative to the total weight of said masterbatch.

Besides the thermoplastic polymer(s) and the ionene polymer(s), the masterbatch according to the present invention can comprise at least one additive.

Any additive usable in the field of plastics engineering is usable in the context of the present invention. A person skilled in the art will be able to determine the additive(s) to add on the basis of the properties desired for the masterbatch or for the item prepared from the latter.

Typically, the additive(s) present in the masterbatch according to the present invention are chosen from the group consisting of plasticisers, dispersants and/or compatibilising agents; agents producing radical species; UV absorbers such as benzotriazoles and hydroxybenzophenones; inhibitors of photo-oxidation such as hindered amine light stabilisers; humidity absorbers such as calcium hydroxide; antioxidants; organic pigments such as the anthraquinones, the phthalocyanines, the polycyclic pigments and the azoic pigments; the inorganic (or mineral) pigments such as titanium dioxide, the pigments containing cobalt, the titanates, the iron oxides, the manganese pigments, the chromium oxides, carbon black and lampblack; thermal stabilisers; fire retardants such as aluminium trihydrate, magnesium hydroxide, inert fillers containing silicon, phosphoric acids and chlorinated hydrocarbons; organic fillers such that mention can be made of wood flour and synthetic or natural fibres; mineral fillers such as talc, graphite, mica, silica and chalk; lubricants (or slip additives) such as calcium stearate, the polyethylene waxes and the silicones and mixtures thereof.

In a specific embodiment, said additive is a plasticiser, dispersant and/or compatibilising agent. The plasticiser(s), dispersant(s) and/or compatibilising agent(s) usable in the context of the present invention include the copolymers of ethylene and of vinyl acetate such as the product marketed under the brand Evatane 2825® by the company Arkema or the product marketed under the brand Viscowax 334® (EVA Wax) by the company Innospec, the waxes such as the polyethylene waxes, the waxes of ethylene copolymers and the oxidised polyethylene waxes marketed in the line Luwax® by the company BTC; the product marketed under the brand BYK® P4102 by the company BYK; the phthalates; the epoxides; the aliphatic dicarboxylic acid esters; the polyethylenes or polypropylenes grafted with maleic anhydride groups (MAG) such as the product marketed under the brand Lushan LR-2D by the company Guanzhou Lushan New Materials; potassium laurate; polyesters; phosphates and mixtures thereof.

In another specific embodiment, said additive is an agent producing radical species. Any agent producing radical species usually used in the context of a reactive extrusion is usable in the context of the present invention. Typically, the agent producing radical species implemented in the context of the present invention is chosen from the group consisting of the hydroperoxides, the organic peroxides, the amines and the azoic compounds having the formula R7-N═N—R8 with the radicals R7 and R8, identical or different, representing an optionally substituted alkyl group as defined above or an optionally substituted aryl group as defined above. In particular, this agent is chosen from the group consisting of the hydroperoxides, the organic peroxides and the mixtures thereof. Agents usable in the invention include the 1,3-1,4-Bis(tert-butylperoxyisopropyl)benzene marketed under the brand Luperox® F40, the benzoyl peroxide marketed under the brand Luperox® A75, the dicumyl-peroxide marketed under the brand Luperox® DCP, the 2,5-dimethyl-2,5-di(tert-butyl-peroxy)hexane marketed under the brand Luperox® 101, the tert-butylcumyl-peroxide marketed under the brand Luperox® 801, the n-butyl-4,4-di(tert-butylperoxy)valerate marketed under the brand Luperox® 230, the 1,1-di(t-butylperoxy)-3,3,5-trimethylcyclohexane marketed under the brand Luperox® 231 and the di-isopropylbenzene hydroperoxide marketed under the brand Luperox® DH, the Luperox® line being sold by the company Arkema.

Advantageously, the additive(s) implemented in the context of the present invention is/are at least one plasticiser, dispersant and/or compatibilising agent and/or at least one agent producing radical species.

When the masterbatch subject-matter of the present invention comprises at least one additional additive, the quantity of this or these additive(s) is between 0.05% and 30% by weight and in particular between 0.1% and 20% by weight relative to the weight of said masterbatch.

In a specific embodiment, when said at least one additive comprises at least one plasticiser, the plasticiser(s), dispersant(s) and/or compatibilising agent(s) is/are present in a quantity of between 0.1% and 20% by weight relative to the weight of said masterbatch.

In another specific embodiment, when said at least one additive comprises at least one agent producing radical species, the agent(s) producing radical species is/are present in a quantity of between 0.05% and 10% by weight relative to the weight of said masterbatch.

The present invention also relates to a method for producing a masterbatch as defined above. This method comprises the extrusion of a mixture comprising at least one thermoplastic polymer in particular as defined above, at least one ionene polymer in particular as defined above and optionally at least one additive in particular as defined above at a temperature less than or equal to 250° C., whereby a masterbatch comprising at least one thermoplastic polymer, at least one ionene polymer and optionally at least one additive is obtained.

During the method according to the present invention, the thermoplastic polymer(s) are typically in the form of pellets. Moreover, the total quantity of thermoplastic polymer(s) in the mixture implemented in the method subject-matter of the present invention is between 50% and 98% by weight, notably between 70% and 97% and, in particular, between 80% and 96% by weight relative to the weight of said mixture.

During the method according to the present invention, the polymer(s) of the ionene type are typically in the form of powders, optionally micronised and/or screened so as to have particles, the size of which is less than 50 μm. The total quantity of polymer(s) of the ionene type in the mixture implemented in the method subject-matter of the present invention is between 0.5% and 50% by weight, notably between 1% and 30% and, in particular, between 2% and 10% by weight relative to the weight of said mixture.

During the method according to the present invention, the optional additive(s) are typically in liquid form or in powder form. The quantity of this or these additive(s) in the mixture implemented in the method subject-matter of the present invention is between 0.05% and 30% by weight and in particular between 0.1% and 20% by weight relative to the weight of said mixture.

In a specific embodiment, when said at least one additive comprises at least one plasticiser, dispersant and/or compatibilising agent, the plasticiser(s), dispersant(s) and/or compatibilising agent(s) is/are present, in the mixture implemented in the method subject-matter of the present invention, in a quantity of between 0.1% and 20% by weight relative to the weight of said mixture.

In another specific embodiment, when said at least one additive comprises at least one agent producing radical species, the agent(s) producing radical species is/are present, in the mixture implemented in the method subject-matter of the present invention, in a quantity of between 0.05% and 10% by weight relative to the weight of said masterbatch.

The extrusion step of the method according to the present invention typically implemented in an extruder is carried out at a temperature of between 100° C. and 250° C., notably between 130° C. and 220° C. and, in particular, approximately 150° C. (i.e. 150° C.±10° C.) or approximately 180° C. (i.e. 180° C.±10° C.). A person skilled in the art will be able to adapt the temperature during the extrusion according to the thermoplastic polymer(s) implemented.

The mixture between the various components that are the thermoplastic polymer(s), the ionene polymer(s) and the optional additive(s) can be produced before its introduction into the extruder and in particular in a mixer or kneader or during its introduction into the extruder. Alternatively, the various components of this mixture can be introduced, into the extruder, one after the other or as a group.

Thus, when the mixture comprises an additive such as a plasticiser, dispersant and/or compatibilising agent and/or an agent producing radical species, the introduction of this agent can be carried out via an injection finger after the mixture of the other components, or during a second go, according to the melting of the mixture, so as to control the action of the agent in particular of the agent producing radical species by acting on the temperature or the residence time in the extruder. It is also possible to introduce the agent producing radical species upstream of the mixture, or before the addition of the ionene polymer and/or of the other additive(s) such as one or more plasticiser(s), dispersant(s) and/or compatibilising agent(s). Also alternatively, this additive such as a plasticiser, dispersant and/or compatibilising agent and/or an agent producing radical species can be introduced, into the extruder, downstream of the zone of introduction of the mixture comprising at least one thermoplastic polymer, at least one ionene polymer and optionally at least one other additive. Typically, at the location at which the plasticiser, dispersant and/or compatibilising agent and/or the agent producing radical species are introduced, the thermoplastic polymer(s), the ionene polymer(s) and optionally the additive(s) are in the form of a viscous or softened, relatively homogeneous phase.

Using, in the mixture implemented in the method according to the invention, an agent producing radical species facilitates the anchoring of the ionene polymers in the thermoplastic matrix of the masterbatch, by creating covalent bonds between the ionene polymers and the thermoplastic polymers forming this matrix. In this case, the extrusion implemented in the preparation method is a reactive extrusion. The latter requires using, as an additive in the mixture, at least one agent producing radical species.

The masterbatch thus prepared is in the form of strands that can then be cut into the shape of pellets and used directly in implementation processes.

The present invention thus relates to the use of a masterbatch as defined above to prepare an item/article having bacteriostatic or bactericidal properties.

Thus, the present invention relates to an item/article having bacteriostatic or bactericidal properties prepared from a masterbatch as defined above.

As mentioned above, the present invention applies to any item with a thermoplastic matrix capable of being used not only in the packaging and the preservation of products but also as a protection, decontamination and/or purification device in the medical-hospital or environmental field. “Item/article with a thermoplastic matrix” means a manufactured item/article, the essential component of which is a thermoplastic resin. This item can thus be chosen from the group consisting of a film such as, for example, a packaging film, a box, a tray, a bottle, a case such as a case for lenses, a sheath, a cover, a bag, dialysis material, a rod, a probe, a membrane and a filter.

The present invention thus relates to a method for preparing an item/article having bacteriostatic or bactericidal properties from a masterbatch as defined above. This method comprises the transformation of the masterbatch as defined above, optionally mixed with a thermoplastic resin into an item.

The masterbatch can be used, directly, after its preparation. Alternatively, it can be diluted in a thermoplastic resin. In this alternative, the method for preparing an item having bacteriostatic or bactericidal properties from a masterbatch as defined above comprises the mixture of the masterbatch as defined above with a thermoplastic resin, whereby a thermoplastic composition is obtained, then the transformation of this thermoplastic composition into an item.

During the mixture step of the method for preparing an item according to the present invention, the quantity of masterbatch is between 5% and 40% by weight and in particular between 8% and 35% by weight relative to the total weight of the thermoplastic composition. Any thermoplastic resin in particular as defined above is usable in the context of the method according to the present invention. This thermoplastic resin can be identical to or different from the thermoplastic polymer(s) comprised in the masterbatch. A person skilled in the art will be able to choose, without inventive effort, the thermoplastic resin best adapted according to the item to be prepared and the thermoplastic polymer(s) already present in the masterbatch.

The formation step in the preparation method according to the present invention can be any shaping technique conventionally used in the field of plastics engineering. Illustrative and non-limiting examples include injection moulding, extrusion moulding, coextrusion moulding, thermoforming, compression moulding, blow moulding, stretch-blow moulding and 3D printing. Thus, the item according to the present invention is in the form of a moulded, extruded, injected item, an item made of films, of sheets, of fibres, of composite materials such as coextruded objects made of multilayer films.

The experimental part below illustrates the preparation by coextrusion of a multilayer film, one of the outer layers of which is prepared from a masterbatch according to the present invention.

The item according to the invention or prepared according to a preparation method according to the invention has, in its thickness and on the surface, ionene polymers. Indeed, these charged polymers have the ability to migrate, in neutral thermoplastics, to the surface of the item thus prepared. The ionene polymers present on the surface of the item allow to confer, onto the latter, bacteriostatic or bactericidal properties and to make it into a bacteria trap.

Even if a part of the ionene polymers can be released from the surface of the items, it is possible to minimise this release in particular by using masterbatches containing additives and/or obtained via a reactive extrusion.

Alternatively, this release can have advantages and be desirable. For example, when the item according to the invention or prepared according to a preparation method according to the invention is an item liable to contain a liquid like a cleaning solution, the release of these ionene polymers into this liquid has a disinfectant role.

Other features and advantages of the present invention will further appear to a person skilled in the art upon reading the examples given below for illustrative and non-limiting purposes, in reference to the appended drawings.

### BRIEF DESCRIPTION OF THE DRAWINGS

FIG. 1 presents epifluorescence microscopy images of the strain Staphylococcus aureus on the films of PE coming from the various masterbatches.

FIG. 2 presents the count in deionised water of the total flora and of the adherent viable cultivable bacteria of S. aureus on the control (nº 2), 10% (nº 4) and 30% (nº 6) MB films of PE.

FIG. 3 presents the count of the adhesion supernatants of S. aureus in deionised water of the control (nº2), 10% (nº4) and 30% (nº6) MB PE films (SS=contaminating stock suspension).

FIG. 4 presents the cytotoxicity results on cellular mats of mouse fibroblasts (L929) in culture for the control (nº2), 10% (nº4) and 30% (nº6) MB PEs, the control corresponds to the same culture medium but without MB PE.

FIG. 5 presents the cytotoxicity results on reconstructed human epidermises in the presence of PBS for the control (nº2), 10% (nº4) and 30% (nº6) MB PEs. The negative control corresponds to PBS alone and the positive control to PBS with an extract of latex glove.

FIG. 6 presents the measurements of water contact angles carried out on a macro and pico-goniometer.

FIG. 7 presents the change in the zeta potential according to the pH for the films of MB PE.

FIG. 8A presents the measurements of release after washing, for a PE—6-6 PI mixture at 3% with 1% EVA Wax (plasticiser, dispersant and/or compatibilising agent) and/or 0.25% peroxide or not.

FIG. 8B presents the measurements of release after washing, for a PE—6-6 PI mixture at 3% with 1% Lushan LR-2D (plasticiser, dispersant and/or compatibilising agent) and/or 0.25% peroxide or not.

FIG. 8C presents the measurements of release after washing, for a PE—6-6 PI mixture at 3% with 1% potassium laurate (plasticiser, dispersant and/or compatibilising agent) and/or 0.25% peroxide or not.

### DETAILED DISCLOSURE OF SPECIFIC EMBODIMENTS

### I. Method for Manufacturing the PE/PI Masterbatches (MB).

### 1.1. Synthesis of the 6-6 PI Polyionene.

The following reactants were ordered from Sigma-Aldrich. The solvents were ordered from Carlo Erba Reagents. All the reactants were used after reception, without additional purification.

All the compounds are introduced into a 250 ml three-neck flask under inert atmosphere, with a coolant above, in the order: the N,N,N′,N′-tetramethyl-1,6-diaminohexane (23.0 mL, 0.1076 mol), 60 mL of methanol, the 1,6-dibromohexane (16.6 mL, 0.1095 mol) and 60 ml of methanol. The reaction mixture, homogeneous and clear, is heated at 65° C. between 6 h and 15 h with stirring. The reaction is stopped by cooling of the reaction medium. The mixture obtained is precipitated in acetone. The precipitate obtained is filtered and dried.

A white solid having a mass m=52.98 g is obtained. 1H NMR (D₂O, δ in ppm): 1.39 (s, 8H); 1.74 (s, 8H); 2.83 (s, 0.27H, amine end); 3.01 (s, 12H); 3.23-3.30 (m, 8H); 3.46-3.49 (t, 0.38H, brominated end).

The polyionene thus obtained is 6-6 PI (or PI 6-6) having the formula:

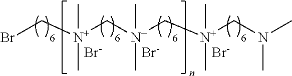

### 1.2. Manufacturing of the MB Containing 6-6 PI and LDPE.

Approximately 150 g of 6-6 PI were synthesised by following the synthesis protocol explained in point 1.1 above. The 6-6 PI obtained has an average molar mass Mw=19 000 g·mol⁻¹ and a polydispersity index of 2.3 (determined by size-exclusion chromatography). The masterbatch (MB) was obtained from a mixture of approximately 950 g of low-density polyethylene (LDPE 410 E, DOW) with 50 g of 6-6 PI which corresponds to an MB with 5% by weight of 6-6 PI. An MB with 3% by weight of 6-6 PI was also prepared from approximately 970 g of LDPE and 30 g of 6-6 PI.

Since the production of the MB requires an extrusion step, the thermal resistance of various PIs was evaluated by thermogravimetric analyses (TGA) under dinitrogen and dioxygen. These analyses allow to affirm that the PIs can be extruded up to a temperature of approximately 250° C., without risk of degradation thereof. The results are grouped together in Table 1 below.

TABLE 1
Thermogravimetric analyses of the PIs under O₂ and N₂

| | | |
|---|---|---|
| T10 (° C.) | T90 (° C.) | Tf (° C.) |

| Samples | O₂ | N₂ | O₂ | N₂ | O₂ | N₂ |
|---|---|---|---|---|---|---|
| 3-3 PI | 262 | 263 | 437 | 348 | 616 | 614 |
| 6-6 PI | 276 | 281 | 357 | 350 | 590 | 621 |
| 6-9 PI | 266 | 260 | 375 | 344 | 614 | 741 |
| 6-12 PI | 255 | 254 | 356 | 344 | 599 | 675 |

T10 represents the temperature of degradation of 10% of the initial mass of the sample, T90, the temperature of degradation of 90% of the initial mass and Tf, the temperature at the end of degradation.

To produce the MB, the finely ground PI powder is introduced into a plastic bag. Pellets of LDPE are added thereto and a jet of pressurised air is injected into the plastic bag to mix the powder with the pellets. The mixture thus obtained is then introduced into a mixer (or compounder) before being extruded at 150° ° C. so as to obtain stands of PE—6-6 PI MB. These strands are then cut up to produce pellets of PE—6-6 PI MB. Approximately 900 g of PE—6-6 PI MB were thus created.

More complex mixtures were also created with the addition of plasticisers, dispersants and/or compatibilising agents (between 0.1% and 20%) to improve the properties of mixture between the two compounds (PE and PI) i.e. to improve the compatibility of the PI in the PE matrix, and thus in fine improve its dispersion in the film (more homogeneous distribution of the PIs). The plasticisers, dispersants and/or compatibilising agents used are the following: Evatane 2528, Luwax A, ViscoWax 334(r)/EVA Wax, BYK P4102, Potassium Laurate, Lushan LR-2D, etc.

Masterbatches were also developed by using reactive extrusion in the presence of peroxides (between 0.05% and 10%) in order to anchor in a more robust manner the PI in the PE (formation of an inter-chain covalent bond). The peroxides used are the line of the Luperox® (F40P, A75, 231, 230, etc.) and all the other formulations that can allow a radical reaction between the polymers involved. The reactive extrusion in the presence of peroxide, with plasticisers, dispersants and/or compatibilising agents or not, involves (1) introducing the mixture comprising the PE and PI and optionally a plasticiser, dispersant and/or compatibilising agent into the mixer, (2) dispersing the PI in the PE whereby a good homogeneity between the phases is obtained, (3) adding peroxide whereby the PI is grafted onto the PE and (4) obtaining a stable homogeneous mixture. It should be noted that the plasticiser, dispersant and/or compatibilising agent can also be added during and/or after the addition of the peroxide.

II. Manufacturing of the Film of PE with the PE—6-6 PI Masterbatch.

Films of PE 100 μm thick are implemented by extrusion at 210° C. (250 or 230 bar) while incorporating the pellets of PE—6-6 PI MB into the pellets of LDPE that form the matrix. The various elements are coextruded on the 9-extruder pilot line of the Tenter type.

The pellets of LDPE and the pellets of PE—6-6 PI MB are introduced via dies, in various proportions, while controlling the flow rate and the masses introduced (filtration 940 μm). They are then melted and mixed during the passage in the screw extruder. A flat die at the output of the extruder allows to obtain multilayer films.

The desired thickness of the film is 100 μm with a 90/10 layer ratio (PE—6-6 PI MB layer). The layer containing the PE—6-6 PI MB is located on the outer part of the film (then inside the roll). The sheath (film of PE—6-6 PI MB), obtained at the output of the extruder, is cooled by sliding on a mandrel, then by immersion in a bath of cold water, in order to be in an amorphous state.

The film is then stretched (long drawing rate of 5 or 4.5) using heated winders moving at various speeds (total flow rate 25 kg/h), before finally being spooled (150 m wound). Films of PE with 10% and 30% by weight of MB in the upper layer were obtained. Since the pellets of MB contain 5% by weight of 6-6 PI, the final films respectively have 0.5% and 1.5% by weight of 6-6 PI.

The film nº2 constitutes the control of the PE matrix without MB. The films nº4 10% MB PE and nº 6 30% MB PE are the films with respectively 0.5% w/w and 1.5% w/w of 6-6 PI in the extruded films.

By choosing pellets of low-density PE (LDPE) to form the main matrix of the film, the migration of the elements to the surface is promoted. This migration is also facilitated by the fact that the polyionene (6-6 PI) is charged and hydrophilic. Thus, although the PI is added to the matrix of the film, it should migrate to the surface and produce an antibacterial effect by contact.

### III. Biological Characterisations of the MB PE Films.

The MB PE films were characterised by microbiology adhesion trials and cytotoxicity trials on mammal cells.

The adhesion tests were completed by a count of the supernatants in order to evaluate the release of these surfaces. Indeed, there are no covalent bonds between the PI and the matrix of PE in the given example i.e. without plasticiser, dispersant and/or compatibilising agent, nor peroxide. Thus, the biological studies were carried out on the MB PE films nº2, nº4 and nº6.

### III.1. Bio-Adhesion Trials.

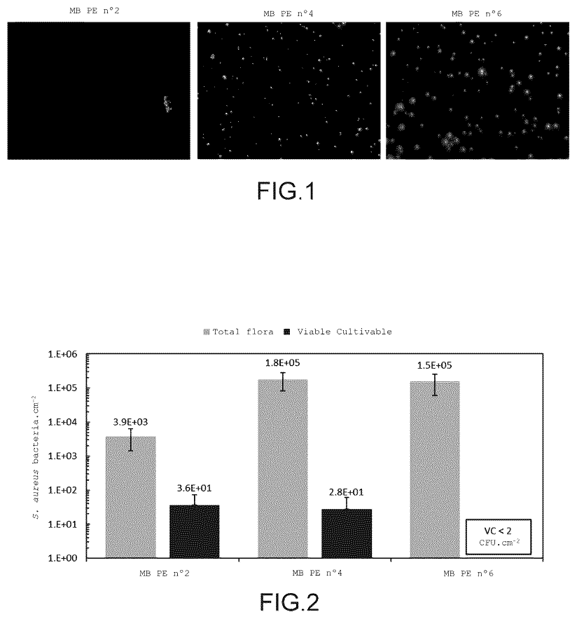

The bio-adhesion trials are tests that allow to reveal the impact of the presence of the PIs on the adhesion of the bacteria (pro-adhesive effect) and to determine the antibacterial effect of the modified materials. On the one hand the total quantity of bacteria that has adhered to the surface, called total flora (TF), is evaluated via a microscopic observation and a count of the bacteria on the epifluorescence images (FIG. 1). On the other hand, the quantity of bacteria alive and capable of multiplying after the exposure to the modified surfaces, called adherent viable cultivable bacteria (VC), is evaluated by unfastening them and by counting them on an agar culture medium.

The adhesion tests are carried out with Staphylococcus aureus (S. aureus) in distilled water for 3 h at 37° C. with a bacterial suspension at approximately 106 CFU.mL⁻¹ (CFU: Colony-Forming Unit). The results presented in FIG. 2 are normalised for a solution at precisely 106 CFU.mL⁻¹, and are the average of five different trials on the control MB PE and 10% MB PE films (n=5), and of three different trials on the 30% MB PE film (n=3). The effectiveness of the unfastening is confirmed by the majority observation of black fields on the materials after the unfastening with ultrasound.

Two significant results can be highlighted in these trials. The total flora is much greater on the 10% and 30% MB PE (those having 6-6 PI) than on the MB control PE. The difference between the quantity of adherent viable cultivable bacteria with respect to the total flora is greater, and significantly, on the 10% and 30% MB PE films than on the control MB PE film. Indeed, the difference is 2.0; 3.8 and 5.9 log bacteria.cm⁻² for the control, 10% and 30% MB PE, respectively.

These two observations thus suggest that the incorporation of the PI into the matrix of PE confers both a pro-adhesive and antibacterial effect onto the films. It should be noted that the difference between the total flora and the count of the viable cultivable flora on the control is significant because of the heterogeneity of the adhesion and the low number of adherent bacteria, which makes the correct counting of the quantity of bacteria (total flora and viable cultivable flora) difficult. However, the antibacterial effect is so great in the case of the MB PEs that their effectiveness with respect to the control is undeniable. The efficiency percentages are 99.98% and 99.9998% on the 10% and 30% MB PEs, respectively.

In the case of the 30% MB PE film, this is a strong bactericidal effect since almost no living bacteria is found in the count of the viable cultivable flora after the exposure to this film. It must be verified that this large effect is only obtained by contact of the bacteria with the film or if it is not also due to a possible release of the PIs into the bacterial suspension that submerges the material.

Bio-adhesion trials were also carried out on the film of 10% MB PE with 10 different bacterial species (wild isolates of meat products).

The pro-adhesive effect is strain-dependent and the trapping capacity of the 10% MB PE is maximum for pathogenic and spoilage bacteria (Table 2). The incorporation of the PIs into the films of PE conferred, onto these surfaces, a targeted bacteria trap property. This is a property of great interest in the context of producing food packaging in order to limit the proliferation of pathogenic and spoilage flora on the food while preserving the useful positive flora for example for good maturing of the meat.

TABLE 2
Summary of the pro-adhesive effect of the
10% MB PE on 10 wild bacterial strains

| Category | Name of the strain | 10% MB PE |
|---|---|---|
| Pathogenic | Staphylococcus aureus | Pro-adhesive effect |
| Spoilage | Pseudomonas sp. | Pro-adhesive effect |
| | Brochotrix | Pro-adhesive effect |
| | Serratia sp. | Pro-adhesive effect |
| Lactic | Lactobacillus casei | Without pro-adhesive effect |
| | Lactobacillus sakei | Without pro-adhesive effect |
| | Leuconostoc mesenteroides | Without pro-adhesive effect |
| | Lactococcus lactis | Without pro-adhesive effect |

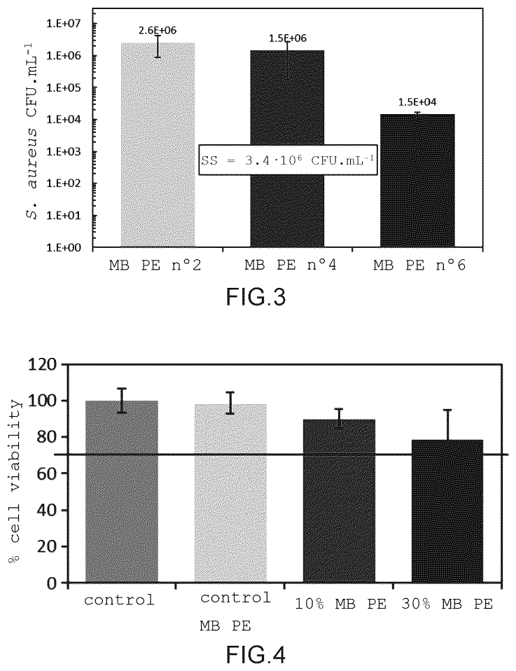

To show the presence of release (that is to say the presence of free PIs released from the surface into the bacterial suspension), the counts of the contaminating suspensions (“supernatants”) used for the adhesion tests were carried out after the 3 h of adhesion. This involved verifying whether the bacteria were inhibited by the film of MB PE only upon contact with the surface, or also in the suspension submerging the material. The counts of the viable cultivable bacteria in the adhesion supernatants are presented in FIG. 3.

A significant decrease in the quantity of viable cultivable bacteria in the supernatant with respect to the contaminating stock suspension (SS) is observed in the case of the film of 30% MB PE. A slight decrease is also perceptible in the case of the 10% MB PE but it is not significant (Student, p-value>0.05). A release is thus proven in the case of the film with the greatest concentration of PI. These trials were completed with a cytotoxicity study in order to evaluate the potential toxicity of the materials and of the release.

### III.2. Cytotoxicity Tests.

To characterise the cytotoxicity of the films, a standardised test, called MTT test, which allows to quantify the cellular viability by measurements of optical density is carried out. The test is carried out according to the standard NF EN ISO 10993-5 which relates to the methods for evaluating the in vitro cytotoxicity of medical devices.

The cytotoxicity tests were carried out, on the one hand, on cellular mats of mouse fibroblasts (L929) after an exposure of 48 h to the MB PE films and, on the other hand, on reconstructed human skin epidermises (Skin+), after an exposure of 24 h to the extruded films. The trials were repeated on three distinct materials for each of the tests (n=3).

Since the MB PE films float above the cellular mats in the wells during the tests on the L929, it is thus possible to evaluate the release with these trials (FIG. 4).

The trials do not indicate any cytotoxicity of the control MB PE and 10% MB PE since the cell viability is above 70%. In the case of the 30% MB PE, the average is also above 70%, but it should be noted that the standard deviation is greater for this trial and that the cytotoxicity threshold is withing the standard deviation of the measurements. A Student's t-test on the data allowed to show that the difference is not significant between the control and the control MB PE film but that it is between the control and the 10% and 30% MB PE films (p-value=0.04 and p-value=0.006, respectively).

Like during the evaluation of the supernatants, this trial also attests to a release proportional to the concentration of PI in the film, and the latter does not generate any cytotoxicity or only potentially in the case of the greatest concentrations of PI.

For the trials on the reconstructed human epidermises, the films of MB PE are in direct contact with the epidermises (FIG. 5).

The trials do not indicate any cytotoxicity of the MB PEs since the cell viabilities are above 70%. Moreover, the Student's t-tests also show that there is no significant difference between the control MB PE and the 10% and 30% MB PEs (p-value>0.05 in both cases). The absence of cytotoxicity of the 30% MB PE on the human epidermises with respect to the L929 cells can be explained by the greater fragility of the L929 cells. The L929s are monolayer cellular mats whereas the reconstructed human epidermises are multilayer systems (at least 5). This makes the reconstructed human epidermises less sensitive to the toxicity than the L929 cells.

In light of the microbiology and cytotoxicity results, the presence of a release for significant loads of PI (30% MB PE) is undeniable. However, the 10% MB PE did not turn out to be cytotoxic in the conditions of the two tests and it has relatively effective antibacterial and pro-adhesive properties with respect to the control MB PE. For this type of extruded materials, according to the intended use, in particular if the release is not desired, the concentration of MB in the outer layer of the film should be limited to 10% (or 0.5% of PI). One possibility envisioned for limiting the release of the PIs is to use a reactive extrusion method in the presence of peroxides, to make the PI react with the PE of the matrix (formation of covalent bonds).

### IV. Physico-Chemical Characterisations of the MB PE Films.

### IV.1. Measurements of Contact Angles.

The measurements of contact angles on all the films (MB PE nº2, nº4 and nº6) were carried out with microscopic drops of D.I. water (2 μL, macro-goniometer) or with smaller quantities (pico-goniometer). The measurements with the pico-goniometer are more precise and also allow to evaluate the homogeneity of the films.

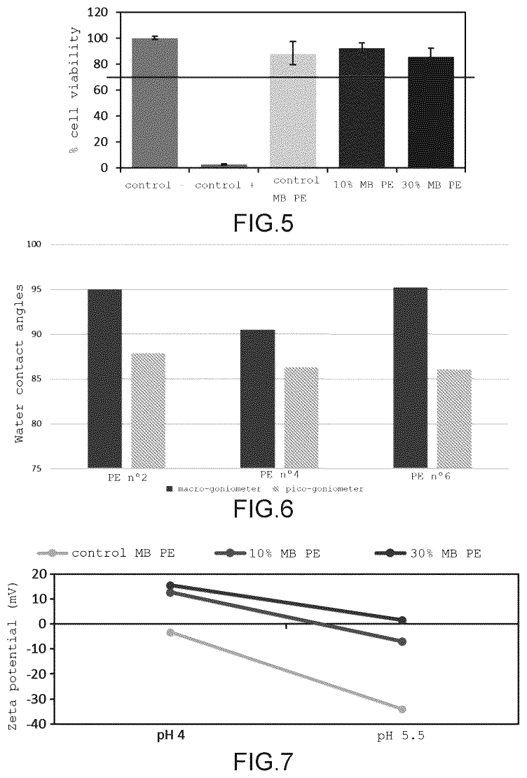

In FIG. 6, it appears that the values of contact angles of the pico-goniometer are smaller than those obtained using the microdrops. Nevertheless, the values obtained follow the same trend, with smaller values of contact angles in the presence of the PIs, with respect to the control MB PE, which indeed confirms their presence on the surface.

### IV.2. Measurements of Zeta Potential.

The zeta potentials were measured on the films of 10% and 30% MB PE (MB PE nº4 and nº6), as well as the film of control MB PE (MB PE nº2). The measurements at pH 4 and 5.5 are indicated in FIG. 7. For both pH values, the 10% and 30% MB PE have zeta potentials greater than that of the control MB PE. This demonstrates a greater quantity of positive charges in the films with the 6-6 PI MBs. The appearance of positive charges on the surface of the 10% and 30% MB PEs confirms the successful migration of the PIs from the PE matrix to the surface of the film.

### IV.3. Study of the Release of the PIs.

Studies of release were carried out on various types of PE-PI mixtures with or without plasticisers, dispersants and/or compatibilising agents, and in the presence of peroxides (Luperox® F40P, 0.25%) or not.

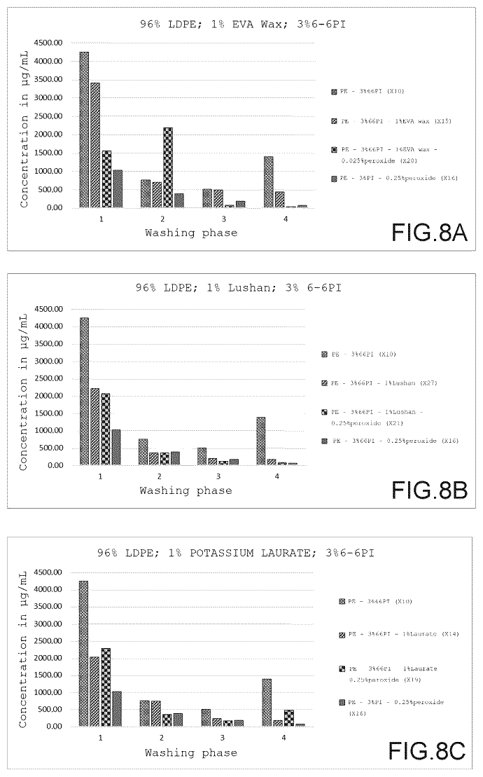

The results presented in FIGS. 8A, 8B and 8C show that the combination PE-PI-plasticiser, dispersant and/or compatibilising agent-peroxide is rather advantageous for reducing the quantity of PI released. However, for the Lushan LR-2D (polymers grafted with maleic anhydride) (FIG. 8B) and the potassium laurate (FIG. 8C), it would appear that the plasticiser, dispersant and/or compatibilising agent alone allows to reduce almost as much the phenomenon of release. For the EVA-Wax (FIG. 8A), the plasticiser, dispersant and/or compatibilising agent alone reduced the release but the addition of peroxide is a plus. Finally, without the presence of plasticiser, dispersant and/or compatibilising agent, the addition of peroxide greatly reduces the release and often more than the plasticiser, dispersant and/or compatibilising agent alone or the peroxide-plasticiser, dispersant and/or compatibilising agent mixture.

### BIBLIOGRAPHY

[1] Guerra et al, J. Food Prot. 2005, 68, 1012-1019.
[2] Habib et al, Polymers 2019, 11, 1704.
[3] Del Nobile et al, Journal of Food Engineering 2009, 93, 1-6.
[4] Nostro et al, Appl. Microbiol. Biotechnol. 2012, 96, 1029-1038.
[5] Dhenavi et al, J. Appl. Polym. Sci. 2013, 127, 1180-1190.
[6] Carvalho et al, Applied Surface Science 2014, 307, 548-557.
[7] Arroyo et al, RSC Adv. 2014, 4, 51451-51458.
[8] Min et al, Biomaterials 2014, 35, 2507-2517.
[9] Becaro et al, J. Nanosci Nanotechno 2015, 15, 2148-2156.
[10] Simbine et al, Food Sci. Technol 2019, 39, 793-802.
[11] Dhende et al, ACS Appl. Mater. Interfaces 2011, 3, 2830-2837.
[12] Kurt et al, Langmuir 2007, 23, 4719-4723.
[13] Strassburg et al, Macromol. Biosci. 2015, 15, 1710-1723.
[14] Lou et al, Acta Biomaterialia 2018, 78, 78-88.
[15] Mattheis et al, Macromol. Biosci. 2012, 12, 341-349.
[16] Liu et al, Biomaterials 2017, 127, 36-48.
[17] International application WO 2020/115434 published on 11 Jun. 2020.
[18] Bernardi et al, Macromol. Biosci. 2020, 2000157.

What is claimed is:

1. Masterbatch obtained by extrusion, comprising
at least one thermoplastic polymer and
at least one ionene polymer which comprises, in its main chain, a sequence of repetitive units, identical or different, each unit being chosen between the unit having the formula (III) and the unit having the formula (IV): 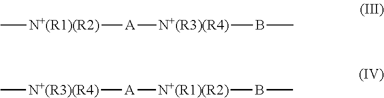
in which
R1, R2, R3 and R4, identical or different, represent an optionally substituted alkyl group or an optionally substituted aryl group;
A is a chain chosen from the group consisting of an optionally substituted alkylene chain, an optionally substituted alkenylene or alkynylene chain, an optionally substituted arylene chain, an optionally substituted alkylarylene chain and an optionally substituted arylalkylene chain; and
B is a chain chosen from the group consisting of an optionally substituted alkylene chain, an optionally substituted alkenylene or alkynylene chain, an optionally substituted arylene chain, an optionally substituted alkylarylene chain and an optionally substituted arylalkylene chain.

2. Masterbatch according to claim 1, wherein at least one thermoplastic polymer is chosen from the group consisting of polyamides; saturated polyesters such as polyethylene terephthalate (PET) and polybutylene terephthalate (PBT); polyvinyl chloride (PVC); polyolefins; styrene polymers such as polystyrene (PS) and acrylonitrile butadiene styrene (ABS); poly(meth)acrylates such as polymethyl methacrylate (PMMA); and combinations or mixtures thereof.

3. Masterbatch according to claim 1, wherein at least one thermoplastic polymer is a polyolefin chosen from the group consisting of polyethylene (PE), low-density polyethylene (LDPE), linear low-density polyethylene (LLDPE), high-density polyethylene (HDPE), polypropylene (PP), polymethylpentene (PMP) and polybutene-1 (PB-1).

4. Masterbatch according to claim 1, wherein the total quantity of said at least one thermoplastic polymer in said masterbatch is between 50% and 98% by weight, notably between 70% and 97% by weight and, in particular, between 80% and 96% by weight relative to the weight of said masterbatch.

5. Masterbatch according to claim 1, wherein at least one polymer of the ionene type comprises, in its main chain, a chaining of repetitive units, identical or different, each unit having the formula (III): 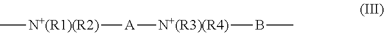
in which
A represents an alkylene comprising from 3 to 12 carbon atoms and in particular 6 carbon atoms,
B represents an alkylene comprising from 3 to 12 carbon atoms and in particular 6 carbon atoms, and
the radicals R1, R2, R3 and R4, identical or different, represent a methyl or an ethyl.

6. Masterbatch according to claim 1, wherein the total quantity of said at least one ionene polymer in said masterbatch is between 0.5% and 50% by weight, notably between 1% and 30% by weight and, in particular, between 2% and 10% by weight relative to the weight of said masterbatch.

7. Masterbatch according to claim 1, wherein masterbatch further comprises at least one additive.

8. Masterbatch according to claim 7, 0 wherein at least one additive is at least one plasticiser, dispersant, compatibilising agent, and/or at least one agent producing radical species.

9. Masterbatch according to claim 7, wherein the quantity of said at least one additive in said masterbatch is between 0.05% and 30% by weight and in particular between 0.1% and 20% by weight relative to the weight of said masterbatch.

10. Method for preparing a masterbatch according to claim 1, wherein said method comprises extrusion of a mixture, said mixture comprising at least one thermoplastic polymer, at least one ionene polymer and optionally at least one additive at a temperature less than or equal to 250° C., whereby a masterbatch comprising at least one thermoplastic polymer, at least one ionene polymer and optionally at least one additive is obtained.

11. Method according to claim 10, wherein said extrusion is a reactive extrusion.

12. An article having bacteriostatic or bactericidal properties prepared from a masterbatch according to claim 1.

13. The article according to claim 12, wherein said article is chosen from the group consisting of a film, a packaging film, a box, a tray, a bottle, a case, a sheath, a cover, a bag, dialysis material, a rod, a probe, a membrane and a filter.

14. Method for preparing an article according to claim 12, said method comprising the transformation of the masterbatch, optionally mixed with a thermoplastic resin, into the article.

15. Preparation method according to claim 14, wherein said method comprises the mixture of the masterbatch with a thermoplastic resin, whereby a thermoplastic composition is obtained, then the transformation of this thermoplastic composition into said article.
